(19) United States
(12) Patent Application Publication
(10) Pub. No.: US 2009/0306923 A1
(43) Pub. Date: Dec. 10, 2009

(54) Method for Measuring the Thickness of Multi-Layer Films

(76) Inventors: Albert Keller, Rueti (CH); Markus Haenggli, Rueti (CH); Philipp Weber, Rueti (CH); Peter Stuker, Rueti (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/084,167

(22) PCT Filed: Oct. 2, 2006
(86) PCT No.: PCT/EP2006/009559

§ 371 Date: Jul. 8, 2009

(30) Foreign Application Priority Data
Oct. 28, 2005 (EP) 05405613.0
Dec. 14, 2005 (EP) 05405697.3
Aug. 8, 2006 (EP) 06405336.6

(51) Int. Cl. G06F 19/00

(52) U.S. Cl. 702/97; 356/73

(57) ABSTRACT

The invention relates to a method for determining the thickness of multi-layer films (13) comprising layers consisting of various non-conductive materials. According to said method, the thickness of the multi-layer film (13) is measured by a first sensor (17) and a second sensor (16) and optionally additional sensors. The first sensor (17) measures the profile of the total thickness in a short cycle with a duration of approximately 1-2 minutes, but with a large measuring error margin. The second sensor (16) measures the profile of the total thickness with a small measuring error margin but in a long cycle with a duration of approximately 10 to 30 minutes. A correction profile for the first sensor (17) can be calculated by comparing the two thickness profiles. Provided that this correction profile remains constant throughout the long cycle, it can be applied to all thickness profiles of the sensor (17) until a new, more accurate thickness profile is made available by the second sensor, permitting the calculation of a new correction profile.

The invention relates to a method for the determination of the thickness of multi-layer films in accordance with the preamble of the independent patent claim 1. Multi-layer films of plastic are built up of a plurality of layers of different materials.

The multi-layer films are manufactured from the various so-called thermoplastics by coextrusion or multi-layer extrusion. Known extrusion methods of this kind are blow extrusion and flat extrusion. In blow extrusion, so-called blow films are produced. The melt is extruded during the blow extrusion out of a ring nozzle and formed into a hose. Air is blown into the hose in order to dilate it. The hose is then laid flat, in many cases is cut into two or more webs and is wound up.

In flat film extrusion the melt is extruded from a slit nozzle. Frequently used thermoplastics are polyethylene (PE), polypropylene (PP), polyamide (PA), ethylene-vinyl-alcohol copolymers (EVOH) and others.

In the manufacture of multi-layer films various thermoplastics with various properties are simultaneously extruded through multiple nozzles and united to the multi-layer film. In many cases it is necessary to introduce so-called bond promoters (HV) between individual layers of the multi-layer film. The bond promoters have the task of improving the bond between layers of the multi-layer film.

Multi-layer films are used in large quantities for the packaging of food. One speaks in this connection of barrier plastics. These multi-layer films have layers which are of low permeability for, for example, oxygen, moisture or otherwise for certain substances which leads to an improved shelf life of the food. For the packaging of food multi-layer films are also used as shrinkable films, as cooking bags, as sterile packaging for dairy products etc. Typical barrier layer films have, for example, a construction
PE or PP
HV
BARRIER LAYER (PA, EVOH)
HV
PE or PP.

Further details concerning multi-layer films, the materials that are used for them and their properties as well as their manufacture can be found in readily comprehensible form in the book “Kunststoff-Folien, Herstellung, Eigenschaften, Anwendung (plastic films, manufacture, properties, uses)” by Joachim Nentwig, Carl Hanser Verlag München Wien, 1994.

In the manufacture of films in general, but in particular also in the manufacture of multi-layer films, the thickness of the films is monitored and, if deviations occur, for example during the manufacture of flat films, the width of the slit of the extrusion nozzles is changed, in order to manufacture as far as possible films of the same thickness. In blow film extrusion, the temperature of the melt or of the cooling air or the quantity of the cooling air is changed locally.

In order, for example, that the quality of the blow film is the same over the entire periphery, the thickness must be uniform over the entire periphery as far as possible. A uniform thickness is amongst other things necessary in order to ensure, for example, uniform printing during the further processing of the film. In order to monitor a uniform thickness in production, or to regulate it through setting elements in the blow head, the thickness profile of the film must be measured.
By way of example the following sensor types are known for the thickness measurement of films.
Capacitive sensors which are influenced by the dielectric constant and/or the damping factor of the film. Capacitive sensors can measure in reflection or in transmission.
Sensors which operate and measure with ionizing radiation, with back-scattering or with absorption.
Sensors which operate and measure in transmission using infrared absorption.
Sensors which operate and measure optically using interference methods.
Sensors which mechanically or pneumatically measure the thickness after the film has been laid flat.
Sensors which measure thermally.
Sensors which use ultrasound and measure transit times, damping, reflection and/or phase shifts.

For the regulation of the thickness of the film it is more favourable to detect the film thickness as quickly as possible after the blow head, i.e. still at the film bubble and not first many metres later after the laying flat. This is, however, only possible with measuring systems which operate at the film bubble solely from the outside with a reflective system. Sensors which operate with the back scattering of ionising radiation are used only unwillingly due to the associated risks and regulations. Optical sensors cannot be used if highly coloured films also have to be measured.

Sensors which operate capacitively in accordance with the reflection principle are, for example, used with advantage for the measurement of the film thickness at the film bubble of blow film extrusion plants. In order to detect the thickness profile of a film bubble on line, a sensor is guided on a ring-like construction around the film bubble. One circuit typically takes 1-2 minutes. The sensor is pressed with a uniform pressure against the film bubble. This enables a very good and accurate online detection of the thickness profile of, for example, PE films.

The measurement signals of capacitive sensors are dependent on the dielectric constant of the material to be measured. The measurement signals of sensors which operate in accordance with the reflection principle are practically directly proportional to the thickness of a film and to the dielectric constant of the material of the film. The dielectric constants of certain materials are temperature-dependent.

In the measurement at multi-layer films which consists of a plurality of layers of thermoplastics with, in part, greatly differing dielectric constants, the measurement of the thickness and of thickness profiles can be faulty. This is because the sensor cannot recognize that, for example, the thickness of the total film and also the thickness of one or more of the layers of the multi-layer film are simultaneously changing in such a way that the error which originates from the thickness of the film and the measurement error which originates through the thickness of a layer of the multi-layer film partly or fully compensate each other. The capacitive sensor detects either no change of the thickness or a false change of the thickness or a change of the thickness which is too high or too low.

Dielectric properties of plastics such as thermoplastics which are used for multi-layer films are to be found for example in the book “Die Kunststoffe und ihre Eigenschaften” (“The Plastics and their Properties”), Hans Domininghaus, Verlag Springer, 1998. On page 128 the dielectric numbers ∈, for example, and the dielectric loss factor tan δ for plastics which are used for multi-layer films are graphically shown in dependence on the temperature. From this it is evident that, if the temperature of the film is also measured and is taken into account in the determination of the correction values and the values of the thickness, this can in many cases contribute to a further increase of the measurement accuracy of the sensors.

In order to avoid the problem with the over-high sensitivity relative to films with very high dielectric constants the capacitive and transmissive measuring system can be used, in production however only after the laying flat when the film is accessible from both sides.

In this method a C-shaped capacitor is arranged at the margin of the laid-flat film. The margin of the film is guided through this sensor. Conclusions are drawn on the changes of the thickness from the change of the capacity of the sensor. The measurement sensitivity of these sensors, which measure in transmission, is directly proportional to the thickness and only little dependent on the dielectric constants of the materials of the film to be measured, since the measured values of capacitive thickness sensors which operate in accordance with the transmission method are practically still only dependent on the thickness of the material from a dielectric constant ∈ᵣ≧5 onwards. Thus one obtains a thickness value with these measurement systems which is significantly more precise with barrier films than the measurement with the capacitive and reflective sensor.

During the measurement the circumstance is exploited that the film hose continuously turns during the laying flat or reversibly turns through 360°. A rotation of the film hose through 360° after the laying flat or through the rotation of the blow head typically lasts for approximately 10 to 30 minutes. As a result, each point on the periphery of the film bubble enters once per revolution or once per reversal into the margin of the film and thus into the region of the C-shaped sensor. Thus, in this method also, the thickness profile of the film is detected over the whole periphery, the whole width. The measurement of the thickness takes place at regular intervals, for example, of one or more centimetres over the periphery of the laid-flat film bubble, so that the periphery of the film bubble is subdivided into segments.

The C-shaped sensor at the film edge admittedly always detects the thickness of two segments together. Through the rotation of the film hose an always new combination of upper and lower segments is located in the measurement range of the sensor. Through this circumstance, the thickness of the individual segments can be determined computationally and can be combined to a thickness profile over the total periphery.

The object of the invention is now to provide a method which combines the advantages of the two methods in order to eliminate their disadvantages: The first capacitive measurement systems which measure reflectively can be placed at the film bubble on a reversing device and can deliver a thickness profile in accordance with the reversing time, approximately in the interval of 1-2 minutes. The measured thickness values are however strongly falsified by different dielectric constants in the different film layers and also by temperature influences.

The second capacitive measurement system, which measures in transmission, can first be placed at the margin of the film after the laying flat and delivers a thickness profile in accordance with the reversing time of the take-off, approximately in the interval of 10-30 minutes. The measured thickness values are however only falsified to a minor degree by different dielectric constants in the different film layers and also by temperature influences.

It is prior art that a more precise result is determined and that the measurement errors of the individual methods can be corrected from a pair of measured values of the same parameter which is detected with different measurement methods.

In this respect either the more imprecise measurement value can be corrected to the quality of the more accurate one or a more accurate result can be determined from the two methods when the dependency of the measurement methods on the product to be measured is known.

For example, it is shown in EP 1 205 293 A1 how the thickness of the individual layers and thus also the total thickness can be correctly measured using capacitive sensors by exploiting the different dependency of the dielectric constant of layers of the multi-layer film on the temperature.

The important point of the invention is that it is not only a more precise result which is obtained from the pair of measured values but rather a correction value is additionally obtained which, together with just one measured value, likewise results in the more precise result again.

In general the accuracy of the measured values which are delivered by a sensor measuring capacity in transmission is sufficient for the regulation of the total thickness. Sufficiently good correction values can thus also be obtained if only the thickness values of the sensor measuring capacity in transmission are used in place of the correct total thickness.

In accordance with the invention the method has the features of the characterizing part of independent claim 1. The dependent claims relate to advantageous embodiments of the invention.

When one of the measured values can be measured in a rapid sequence the other however only in a slow sequence then, in place of the slow measured value, the correction value can be so modified with the faster measured value so that corrected values arise in a rapid sequence through this extrapolation.

To measure faster signifies in the present document that the profile is measured by one sensor in a shorter time than with another sensor. Vice versa, slowly in the present document means that the sensor for the measurement of the profile needs more time than the sensor which measures quickly.

In the described application for the measurement of a thickness profile the correction value is not a constant but rather a value which is dependent on the position on the periphery of the film bubble. The whole series of the correction values around the periphery is designated the correction profile.

Under the assumption that the effect which causes the deviation of the measured value of the total thickness for the individual sensor remains constant over a longer period of time at each film position, it is possible to use this correction profile which was determined earlier and stored for the subsequent profiles for the correction of the measured values of the individual sensor, in place of the measured values of the other sensor, in order to determine the correct value of the total thickness.

Instead of using capacitive sensors as is described in the embodiment sensors can also be used with operate in accordance with other principles or a capacitive sensor and a sensor operating in accordance with another principle can be used. It is important only that the measured signals of the sensors have different sensitivity for, for example, thermoplastics from which the multilayer film is built up, i.e. that the slower system enables a substantially more accurate measurement.

The invention will be explained in the following in more detail with reference to the schematic drawing.

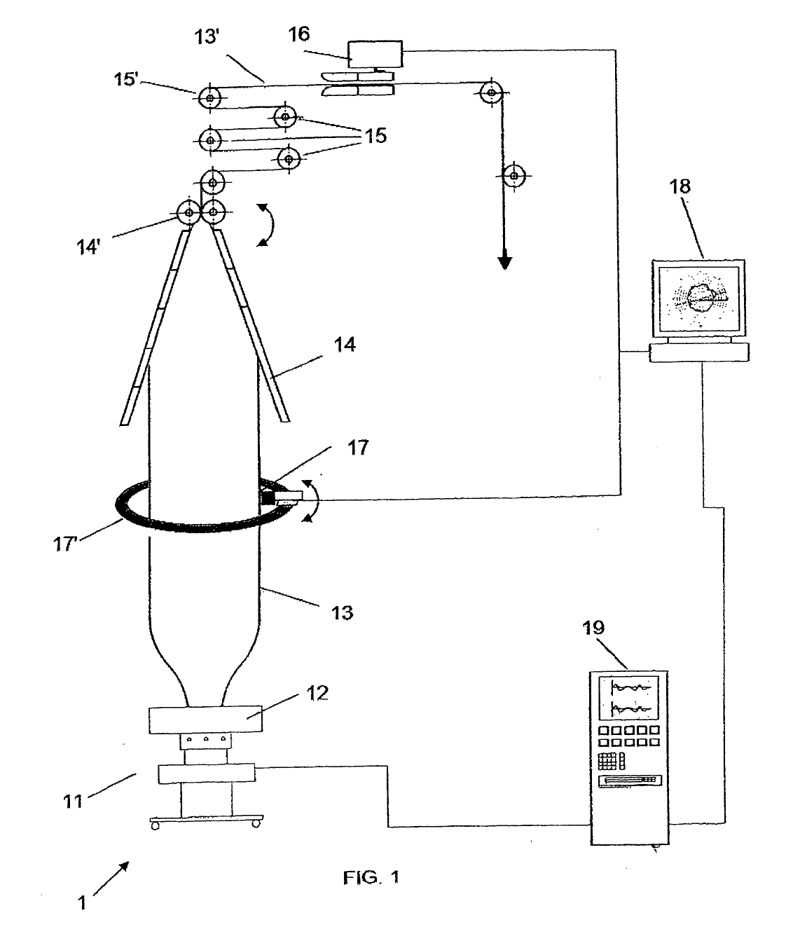

The single FIG. 1 shows the schematic principle of a multi-layer film blow extrusion plant at which the thickness is measured and monitored in accordance with the method of the present invention.

The manufacture of films takes place in the blow film extrusion plant 1 as follows: From the extruder with a multiple ring nozzle (not shown) the emerging melt of the various thermoplastics is formed into a hose. This film hose is drawn off at a speed which is larger than the outlet speed of the melt. Through a connection for compressed air in the blow head 11 with the mould tool 12 the hose is inflated to the film bubble 13. At the end of the laying flat section 14 the film bubble is squashed with two squashing rolls 14′. The laid-flat film hose 13′ is then directed (arrow) to a winding device (not shown) and wound up to form a reel.

The thickness of the film is measured at the film bubble 13 with a first sensor 17, for example a capacitive sensor, which operates in accordance with the reflection principle. The sensor moves reversibly on a track 17′ around the film bubble 13 and back. The sensor can also run continuously around the film bubble 13. The reversing procedure or the circuit time lasts approximately one minute to several minutes.

After the squashing rolls 14′ the film hose is guided over the turning bars 15 to the fixed roll 15′. The reversing device with the turning bars 15 ensures that the marginal regions of the squashed film bubble shift over the entire periphery of the film bubble.

This has the consequence that, when the thickness is measured at the margin of the laid flat film hose 13′ with the second sensor 16, a profile of the thickness is measured around the film bubble transverse to the running direction. The sensor 16 operates, for example, capacitively in transmission.

The measured values of the two sensors 16 and 17 are fed to the computer. The computer 18 calculates from them a corrected value for the thickness and also a correction value or a correction profile for the sensor 17 which will be explained in more detail in the following.

The profile of the total thickness, which the computer 18 calculates, are passed to the console 19 with which the plant 1, i.e. the extrusion process, is controlled and regulated. The determined values for the total thickness can, for example, be shown graphically and/or numerically on the screen of the computer 18.

The values for the thickness can also be transferred to the console 19 for the control, regulation, monitoring and setting of the multilayer film blow extrusion plant, where the data can likewise be shown on a screen. Finally, provision can also be made that the console 19 regulates and controls the thickness of the film as a result of the thickness values determined in accordance with the method in the computer 18, as has already been explained earlier.

The two sensors 16 and 17 have as a result of their different operating principles different sensitivity for individual layers of the multilayer films. The measurements and measured values of the sensor 17 which measures reflectively are directly proportionally dependent on the thickness and directly proportionally dependent on the dielectric constants of the multilayer film. Moreover, this dielectric constant can be strongly dependent on the temperature of the film.

The measurements of the sensors 16 which measures the thickness in transmission are in contrast only little dependent on the dielectric constant of the materials of the multilayer film. It has been shown that the measurement accuracy of the total thickness which is achieved with this method satisfies the requirements in the practice.

Above all the non-capacitive measurement methods listed in the description are completely independent of the dielectric constants.

In the following will be shown, as an example, how the correction profile can be calculated from the measured values of the two sensors 16 and 17 on the assumption that the measurement accuracy of the second sensor 16 is accepted as being sufficiently accurate. In this respect the definitions of Table 1 are used.

TABLE 1
THE DESIGNATIONS USED/THEIR SIGNIFICANCE

| Sign | Significance |
|---|---|
| D1 | Measured thickness value of the sensor 16 which is little depen- |
| | dent or not dependent on the dielectric constant εᵣ |
| D2 | Measured thickness value of the sensor 17 which is proportionally |
| | dependent on the dielectric constant εᵣ |
| D | Total thickness of the film sufficiently good measurement or value |
| | calculated from the combination of D1 and D2 |
| Kf | Correction factor per point of the profile |

Through the combination of the measurement data D2 from the sensor 17 and D1 from the sensor 16 the profile of the total thickness D can be more precisely determined than only with the sensor 16 or with the sensor 17 alone. This is prior art. In EP 1 205 293 A1 it is for example shown that the thicknesses of the individual layers can be calculated using capacitive sensors at these positions. Thus, the correct total thickness can also be determined.

From the combined total profile D a correction value D/D2 is then calculated per profile point by comparison with the profile D2 determined by the sensor 17, which results in a correction profile. Either the correctly calculated thickness or, for simplification, also only the result of the second sensor can be used as the total profile D. The quality of the extrapolation which is thereby calculated reaches, in the best case, that of the total profile that is used.

The measurement is considered to be sufficiently accurate when the measurement error in the transverse profile is smaller than 2 to 3% which corresponds to the fluctuations of the thickness in the production direction.

The goal must therefore be to achieve at least this accuracy with an extrapolation and indeed with the detection speed of the faster measuring sensor 17.

The thickness profile can be quickly measured with the sensor 17 on the track 17′; however, in a multilayer film with much PA, the measured profile is much more influenced by the proportion of PA than by the total thickness. It is however the total thickness which is intended to be regulated to a profile which is as flat as possible.

With the sensor 16 the total profile is influenced substantially less by the proportion of PA; however, the measurement takes approximately 5 to 10 times longer, which is disadvantageous for the regulation of the profile.

On the assumption that the proportion of PA and its influence on the measurement sensor and the measurement apparatus remains constant in relationship to the total thickness for a long time (longer than 30 minutes) and thus that the correction profile also remains constant, the rapid measurements of the sensor 17 can be corrected (fast=short time for the measurement of a profile, which corresponds to the circuit time of the sensor 17 around the film bubble 13) as soon as a first correction profile is determined from the slower sensor 16.

For the correction of the next profile D2′ determined with the sensor 17 each profile value is multiplied by the corresponding correction value of the correction profile.

The correction value depends essentially on the ratio DA/DE i.e. DA/D. An important additional influence is also the temperature in view of the temperature dependence of ∈ᵣ(PA). It is assumed that the proportion of PA per profile point remains constant. It is assumed that the temperature distribution and thus the temperature profile also remains constant over the periphery of the film bubble, which is also confirmed by the temperature measurement that is carried out. Thus the influence of the temperature distribution over the periphery of the film bubble can be corrected with the correction profile.

If, for example, the profile of the second sensor 16, for example that of a sensor measuring capacitively in transmission is taken directly as the total profile as a starting point for the creation of the correction profile then the equations of Table 2 apply.

If the sensors enable a thickness measurement of the individual layers then correction factors for each individual layer can also be determined accordingly.

TABLE 2
EXTRAPOLATION OF THE TOTAL THICKNESS

| | Equation | | |
|---|---|---|---|
| | No. | | Remark |
| Sensor 16 | (I) | D = D1 | Reference profile sensor 16 |
| Sensor 17 | (II) | D = Kf * D2 | Reference profile sensor 17 |
| | (III) | Kf = D/D2 | Correction factor per point |
| | | | of the profile |
| Sensor 17 | (II)′ | D′ = Kf′ * D2′ | New profile measured by the |
| | | | sensor 17 |
| | (IV) | Kf′ = Kf | Assertion and approximation |
| | | | for extrapolation |
| | (II)′ and | D′ = D2′ * Kf | Extrapolation from D2′ with |
| | (IV) | | the correction factor per profile |
| | | | point |

With reference to experiments with test profiles it was found that the extrapolation is considerably better and more accurate than the measurement with the sensor 17 alone. If the correctly calculated value for the total thickness is used in the equation 1 then the extrapolated value is also better than the measurement with the sensor 16 alone. Even sensors 16 and 17 of the measurement apparatus which are poorly matched to one another still enable a good extrapolation.

In the method for the determination of the thickness of multilayer foils 13 with layers of various non-conductive materials, the thickness of the multiple layer film 13 is measured with a first sensor 17 and with a second sensor 16 and optionally with further sensors. The first sensor 17 measures with a short cycle time of ca. 1-2 minutes the profile of the total thickness but with a large measurement error. The second sensor 16 measures the profile of the total thickness with a small measurement error but with a long cycle time of 10 to 30 minutes.

A correction profile can be calculated for the first sensor 17 by the comparison of the two thickness profiles. On the assumption that this correction profile remains stable over the long cycle time all thickness profiles of the sensors 17 can be modified with this correction profile until a more accurate thickness profile is available from the second sensor and thus a new correction profile can be calculated.

1. Method for the determination of the total thickness and/or of individual layers of multiple layer films (13) with layers of different non-conducting materials in which correction values for at least one of the sensors (16 or 17) are determined from the measured values for the thickness of at least two sensors (16, 17) operating in accordance with different measurement principles, from which the correct total thickness of the multi-layer film and/or the thickness of individual layers of a multi-layer film are determined for at least one subsequent measurement from the measured values of only one sensor and the correction values for this sensor (16 or 17).

2. Method for the correction of a series of measured values from measured values of the thickness at a multi-layer film (13) with layers of different non-conductive materials using a first sensor (17) characterized by a further sensor (16) or a plurality of further sensors, with the first sensor and the further sensor or sensors producing different measured values for layers of the same thickness of the same material of the multi-layer film (13) and with the measurement signals of the sensors (16, 17) being fed to a computer which determines the correct total thickness of the multi-layer film (13) from the different measured values of the first sensor (17) and of the further sensor or further sensors (16) and calculates a correction profile from the ratio of this correct total thickness to the values measured by the sensor (16 and/or 17) and with this correction profile being used to so correct a next series of measurements or a plurality of next series of measurements of the sensor (16 and/or 17) that a correct measured value of the thickness again results from it.

3. Method in accordance with claim 1, in which the first sensor (17) that is used and the second sensor or sensors (16) with which the same thickness of multi-layer films (13) produce different measured values are the following types of sensors:
capacitive sensors (16, 17) which measure in reflection or transmission, and/or
sensors with ionising radiation which measure the back-scattering of the radiation or the penetrating radiation, and/or
sensors with infrared radiation which measure the infrared absorption, and/or
optical sensors which measure with interference methods and/or
pneumatic or mechanical sensors for the measurement of the thickness of the foils, and/or
thermal sensors, and/or
sensors which measure the thickness of the multi-layer film with ultrasound.

4. Method in accordance with claim 1 for the determination of the thickness of multi-layer films (13) of layers of materials with different dielectric number ∈ᵣ in which the first sensor (17) operates capacitively in accordance with the reflection method (in reflection) and the second sensor (16) operates capacitively in accordance with the transmission method (in transmission).

5. Method in accordance with claim 1 for the determination of the thickness of multi-layer films (13) of layers of materials with different dielectric constants ∈ᵣ and/or different dielectric loss factors tan δ.

6. Method in accordance with claim 1, in which
the first sensor operates with a measurement principle the measured thickness values of which strongly depend and preferably directly proportionally dependent on the dielectric constant ∈ᵣ of the material of the film, in particular with a sensor which operates and measures with the capacitively and reflectively operating measurement principle and
the second sensor operates with a measurement principle of which the measured thickness values are not or are only weakly dependent on the dielectric constant ∈ᵣ of the material of the film and of the layers of the film, preferably with a sensor which measures the thickness of the film capacitively in transmission or with a sensor which measures with the back-scattering of ionizing radiation or with a sensor which measures the thickness of the film with an optical interference method.

7. Use of the method in accordance with claim 1 in a multi-layer film blow extrusion plant for the measurement, monitoring and/or the regulation of the total thickness of multi-layer films (13).

8. Use of the method in accordance with claim 1 for the measurement, monitoring and/or regulation of the thickness of multi-layer films (13) in a multi-layer film blow extrusion plant, with the first sensor (17) measuring the thickness of the film (13) at the film bubble and the second sensor (16) measuring the thickness of the film at the margin of the laid-flat film (13′)
